(19) United States
(12) Patent Application Publication
(10) Pub. No.: US 2003/0129331 A1
(43) Pub. Date: Jul. 10, 2003

(54) Fins and profiles for plastic bags

(76) Inventors: Paul N. Chen, Canandaigua, NY (US); Steven P. Long, Canandaigua, NY (US); Thomas A. White, Farmington, NY (US)

Correspondence Address: JENKENS & GILCHRIST, P.C., 225 WEST WASHINGTON, SUITE 2600, CHICAGO, IL, 60606, US

(21) Appl. No.: 09/967,313

(22) Filed: Sep. 28, 2001

Related U.S. Application Data
(63) Continuation-in-part of application No. 09/948,865, filed on Sep. 7, 2001.

(51) Int. Cl. B32B 1/02

(52) U.S. Cl. 428/34.2; 428/99

(57) ABSTRACT

A fastener for a plastic bag comprising a male track including a male profile and a first fin extending from the male profile and a female track including a female profile and a second fin extending from the female profile. The first fin includes a first fin portion and the second fin includes a second fin portion. The first and second fin portions are joined to each other along a one-time breakable preferential area of weakness. At least one of the first and second fins and/or one of the male and female profiles comprises a cyclic olefin copolymer or a combination of a cyclic olefin copolymer and one or more additional polymers. The cyclic olefin copolymer has a glass transition temperature, T_{g}, of greater than about 20° C. as determined by ASTM D3418. The additional polymer is selected from a polyolefinic resin, an engineering resin, and a combination thereof.

### CROSS REFERENCE TO RELATED APPLICATIONS

The present application is a continuation-in-part of U.S. patent application Ser. No. 09/948,865 entitled “Fins and Profiles for Plastic Bags” filed on Sep. 7, 2001.

### FIELD OF THE INVENTION

The present invention relates generally to plastic bags. More particularly, the present invention relates to the use of materials in plastic bags to strengthen the fins and/or profiles of fasteners in plastic bags.

### BACKGROUND OF THE INVENTION

Plastic bags are in widespread use in a varied and diverse number of household and commercial applications, especially in the food packaging industry. One advantage of plastic bags is their ease of opening and resealing. Some of these bags are reclosable via the use of a reclosable feature such as a reclosable fastener. In many bags, the fasteners can be opened and closed either by pressure or by the use of an auxiliary slider mechanism.

A factor which affects the acceptance and range of application of plastic bags is the strength and reliability of the reclosable fasteners on the bags. Many of the presently available reclosable fasteners are made of materials such as low density polyethylenes and linear low density polyethylenes which do not have sufficient mechanical strength to prevent the fasteners from opening. The failure of the fasteners may result in spillage of the contents of the bags and can lead to extreme customer dissatisfaction.

Another factor which affects the acceptance and range of application of plastic bags having reclosable features such as reclosable fasteners is that the reclosable features do not provide a leak proof barrier. Thus, the contents of the bag can leak out of the package and the external atmosphere can leak into the bag, promoting food spoilage. A further problem which affects the acceptance and range of application of plastic bags having reclosable features such as reclosable fasteners is that such packages can be easily tampered with prior to purchase by the consumer.

Since the popularity of plastic bags has placed increased demands on the tasks they are asked to perform, a need exists for bags having fasteners that are able to withstand increased forces and more adverse conditions. A need also exists for bags having a leak and tamper proof seal in addition to having reclosable fasteners that are able to withstand increased forces and more adverse conditions. It would be especially advantageous to place such a leak and tamper proof seal below the reclosable feature (closer to the food product) such that the tamper proof seal would not interfere with the operation of the reclosable feature.

### SUMMARY OF THE INVENTION

According to one embodiment, a fastener for a plastic bag comprises a male track including a male profile and a first fin extending from the male profile and a female track including a female profile and a second fin extending from the female profile. The first fin includes a first fin portion and the second fin includes a second fin portion. The first and second fin portions are joined to each other along a one-time breakable preferential area of weakness. At least one of the first and second fins comprises a cyclic olefin copolymer. The cyclic olefin copolymer has a glass transition temperature, T_{g}, of greater than about 20° C. as determined by ASTM D3418. The cyclic olefin copolymer may comprise from about 10 to about 90 mol. % norbornene. At least one of the first and second fins may comprise an additional polymer selected from a polyolefinic resin, an engineering resin, and a combination thereof.

According to another embodiment, a fastener for a plastic bag comprises a male track including a male profile and a first fin extending from the male profile and a female track including a female profile and a second fin extending from the female profile. The first fin includes a first fin portion and the second fin includes a second fin portion. The first and second fin portions are joined to each other along a one-time breakable preferential area of weakness. At least one of the male and female profiles comprises a cyclic olefin copolymer. The cyclic olefin copolymer has a glass transition temperature, T_{g}, of greater than about 20° C. as determined by ASTM D3418. The cyclic olefin copolymer may comprise from about 10 to about 90 mol. % norbornene. At least one of the male and female profiles may comprise an additional polymer selected from a polyolefinic resin, an engineering resin, and a combination thereof.

According to a further embodiment, a polymeric bag comprises first and second opposing body panels fixedly connected to each other along a pair of sides and a bottom bridging the pair of sides and a reclosable fastener extending along a mouth formed opposite the bottom. The fastener includes a pair of interlocking flexible plastic tracks including a male track including a male profile and a first fin, the first fin extending from the male profile and a female track including a female profile and a second fin, the second fin extending from the female profile. The first fin includes a first fin portion and the second fin includes a second fin portion. The first and second fin portions are joined to each other along a one-time breakable preferential area of weakness. At least one of the first and second fins comprises a cyclic olefin copolymer. The cyclic olefin copolymer has a glass transition temperature, T_{g}, of greater than about 20° C. as determined by ASTM D3418. The cyclic olefin copolymer may comprise from about 10 to about 90 mol. % norbornene. At least one of the first and second fins may comprise an additional polymer selected from a polyolefinic resin, an engineering resin, and a combination thereof. The bag may comprise a slider slidably mounted to the fastener for movement between a closed position and an open position.

According to a still further embodiment, a polymeric bag comprises first and second opposing body panels fixedly connected to each other along a pair of sides and a bottom bridging the pair of sides and a reclosable fastener extending along a mouth formed opposite the bottom. The fastener includes a pair of interlocking flexible plastic tracks including a male track including a male profile and a first fin, the first fin extending from the male profile and a female track including a female profile and a second fin, the second fin extending from the female profile. The first fin includes a first fin portion and the second fin includes a second fin portion. The first and second fin portions are joined to each other along a one-time breakable preferential area of weakness. At least one of the male and female profiles comprises a cyclic olefin copolymer. The cyclic olefin copolymer has a glass transition temperature, T_{g}, of greater than about 20° C. as determined by ASTM D3418. The cyclic olefin copolymer may comprise from about 10 to about 90 mol. % norbornene. At least one of the male and female profiles may comprise an additional polymer selected from a polyolefinic resin, an engineering resin, and a combination thereof. The bag may comprise a slider slidably mounted to the fastener for movement between a closed position and an open position.

The above summary of the present invention is not intended to represent each embodiment, or every aspect, of the present invention. This is the purpose of the figures and the detailed description which follow.

### BRIEF DESCRIPTION OF THE DRAWINGS

The foregoing and other advantages of the invention will become apparent upon reading the following detailed description and upon reference to the drawings.

FIG. 1 is a perspective view of a thermoplastic bag having a fastener and slider and incorporating a tamper proof feature formed by joined fin portions located below a reclosable fastener arrangement;

FIG. 2 is an enlarged perspective view of the fastener and slider of FIG. 1 in assembled position on a thermoplastic bag;

FIG. 3 is a sectional view of the fastener of FIGS. 1 and 2 taken generally along line 3-3 in FIG. 2;

FIG. 4 is a sectional view of a fastener having fins comprising two layers and having a tamper proof feature according to one embodiment of the present invention;

FIG. 5 is a sectional view of a fastener having fins comprising three layers and having a tamper proof feature according to a further embodiment of the present invention;

FIG. 6 is a sectional view of a fastener having fins comprising four layers and having a tamper proof feature according to another embodiment of the present invention;

FIG. 7 is a sectional view of a fastener having fins comprising five layers and having a tamper proof feature according to yet another embodiment of the present invention;

FIG. 8 is a sectional view of a fastener constructed in accordance with another embodiment of the invention;

FIG. 9 is a sectional view of a fastener having profiles comprising two layers and having a tamper proof feature formed by joined fin portions located below a reclosable fastener arrangement according to another embodiment of the present invention;

FIG. 10 is a sectional view of a fastener constructed in accordance with another embodiment of the invention;

FIG. 11 is a sectional view of a fastener constructed in accordance with a further embodiment of the invention; and

FIG. 12 is a sectional view of a fastener constructed in accordance with a still further embodiment of the invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

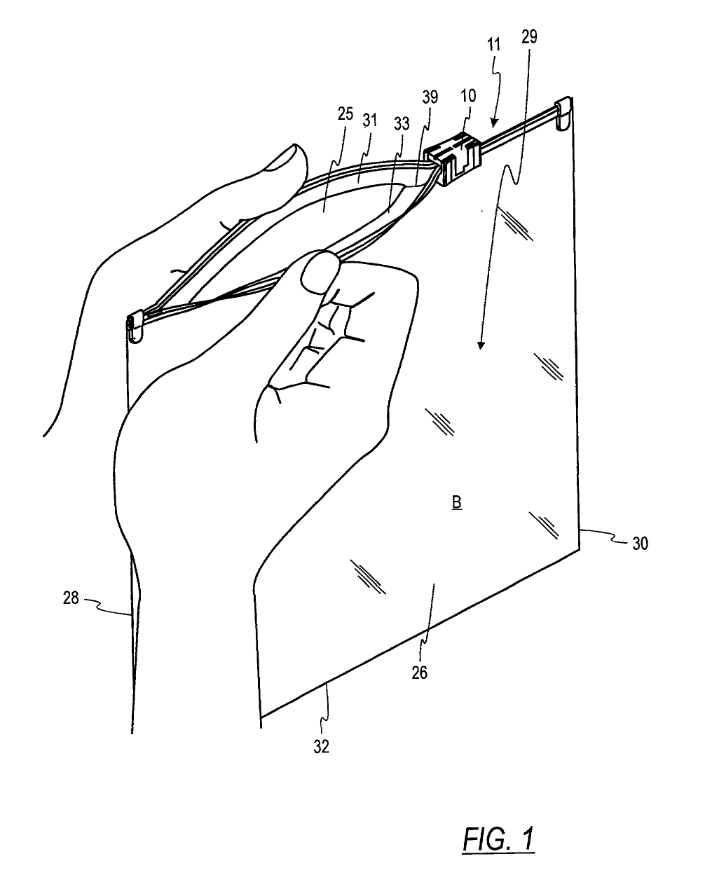

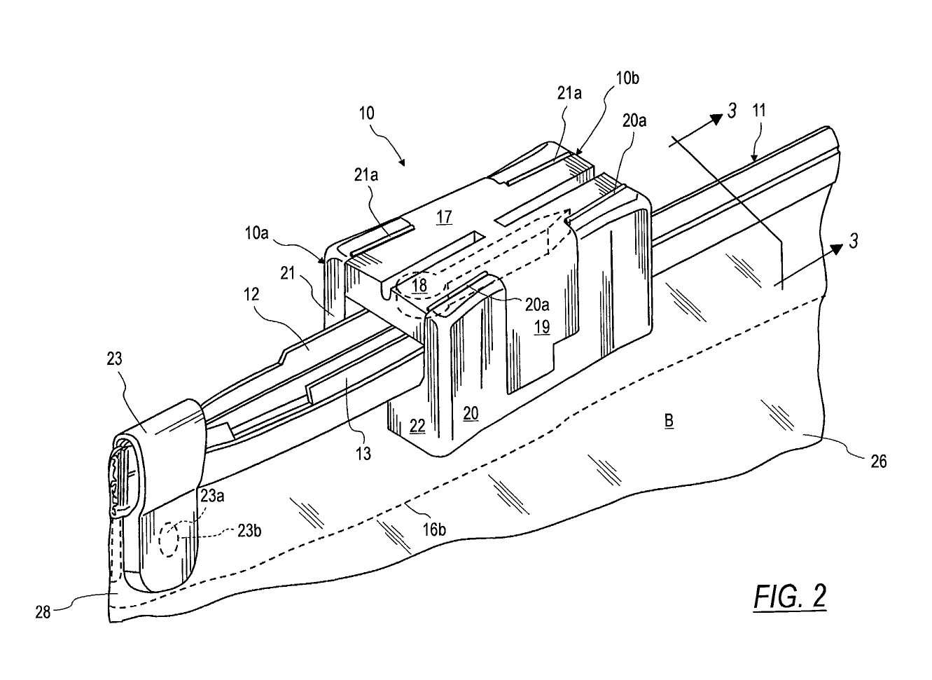

Referring to FIGS. 1-3, there is illustrated a plastic slider 10 and a profiled plastic fastener or zipper 11 having a mouth portion having a tamper evident feature 34 located below the fastener 11. The slider 10 and fastener 11 are particularly suited for thermoplastic bags and the like. Slider 10 has been illustrated in FIG. 2 assembled on the fastener 11 at the top edge or mouth of a thermoplastic bag B. The plastic slider 10 and the profiled fastener 11 cooperate to close the bag B. To assist in opening the bag, the slider 10 is slidably mounted to the fastener 11 for movement between a closed position and an open position.

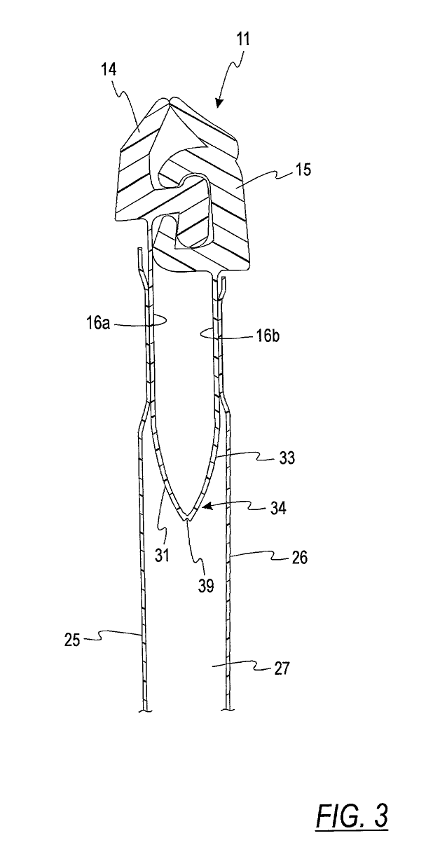

Bag B (as shown in FIGS. 1 and 2) is formed from a single flexible plastic sheet folded upon itself and comprises first and second opposing body panels 25, 26. Body panels 25, 26 are fixedly connected to each other along a pair of sides 28, 30 and a bottom 32 which extends between the pair of sides 28, 30. The fastener 11 (as shown in FIG. 2) extends along the top edge or mouth formed opposite the bottom 32 of bag B, in which the fastener 11 has a male track 12 and a female track 13. As shown in FIGS. 1 and 3, the mouth portion of bag B includes the first and second opposing body panels 25, 26 which make up a package body 29 and define a receptacle space 27.

Alternatively, bag B may be formed from separate plastic sheets where the first and second opposing body panels are sealed after being initially separated so as to form the pair of sides and the bottom (i. e., sealed on three sides). Alternatively, bag B may be formed from a single flexible plastic sheet having a side fold, a seal on the side opposite the side fold, and an end seal (not shown).

Alternatively, bag B (not shown) may be a stand-up polymeric bag which comprises first and second opposing body panels and a bottom wall and a reclosable feature or fastener, such as a reclosable zipper which can be opened and closed either by the use of an auxiliary slider mechanism, by finger pressure, or by an auxiliary squeezing device other than an auxiliary slider mechanism. The first and second opposing body panels are coupled to opposing portions of the bottom wall. The bottom wall may be a gusseted bottom wall comprising gusseted portions or may be comprised of configurations other than a gusseted bottom wall. One example of a stand-up polymeric bag is shown in U.S. Pat. No. 6,148,588 to Thomas et al. As will be discussed below, the materials which may be used in the reclosable feature or fastener of the stand-up polymeric bag comprise at least one polymeric material which possesses excellent resistance to stress and superior strength properties. In particular, is a cyclic olefin copolymer may be used in the reclosable feature or fastener of the stand-up polymeric bag. It is contemplated that the reclosable feature or fastener may comprise 100 wt.% cyclic olefin copolymer or may comprise a combination of a cyclic olefin copolymer and one or more additional polymers as discussed below with respect to the fins 16a, 16b and/or the profiles 14, 15 of the bag.

As shown in FIGS. 2 and 3, male and female tracks 12, 13 have interlocking male and female profiles 14, 15 extending the length thereof in the form of rib and groove elements on the respective tracks. The male and female profiles 14, 15 are releasably engageable with each other to provide a reclosable seal to the bag B. The male track 12 includes a male profile 14 and a first depending fin or flange 16a extending downward from the male profile 14. The first depending fin or flange 16a includes a first fin portion 31 as shown in FIG. 3. Likewise, the female track 13 includes a female profile 15 and a second depending fin or flange 16b extending downward from the female profile 15. The second depending fin or flange 16b includes a second fin portion 33 as shown in FIG. 3. The fins 16a, 16b are shown attached to opposing body panels 25, 26 in FIG. 3. The tracks 12, 13 may be extruded separately with fins 16a, 16b and attached to the respective sides of the bag mouth or the tracks 12, 13 may be extruded integral with the sides of the bag mouth. If the tracks 12, 13 are extruded separately, they are most effectively attached by means of the respective first and second fins 16a, 16b, incorporated within the tracks, such as by heat sealing to the bag mouth.

In the illustrated embodiment, the lower edges of the first and second fin portions 31, 33 of the fins 16a, 16b are joined to each other along a one-time breakable preferential area of weakness or preferential tear area 39 to form a one-time openable tamper evident feature 34. The joined first and second fin portions 31, 33 have a generally U-shaped or V-shaped cross-sectional configuration.

To join the first and second fin portions 31, 33 of the fins 16a, 16b, the first and second fin portions 31, 33 may be coextruded as a single continuous fin having the preferential area of weakness 39. In one embodiment, the preferential area of weakness 39 takes the form of a perforated line, score line, or thinned line. A score line is created by making a uniform crease at the intersection of the fin portions 31, 33. A thinned line is created by coextruding the fin portions 31, 33 with less plastic material along the region joining the lower edges of the fin portions 31, 33. In another embodiment, the preferential area of weakness 39 results from forming a single continuous fin out of highly oriented plastic that has a tendency to split along the preferential area of weakness 39.

Instead of coextruding the first and second fin portions 31, 33 as a single continuous fin, the first and second fin portions 31, 33 may be separately extruded and then later weakly attached at their lower edges or some other location by heat sealing, welding, or the like. The weak attachment of the first and second fin portions 31, 33 creates the preferential area of weakness 39.

The male and female profiles 14, 15 have complementary cross-sectional shapes. The cross-sectional shapes of the interlocking male and female profiles 14, 15 shown in FIG. 3 are the subject of the invention claimed in U.S. Pat. No. 5,007,143 to Herrington, which is incorporated herein by reference.

In the open position of the slider 10, the male and female profiles 14, 15 are disengaged from each other so that a user can gain access to the interior of the bag B. Movement of the slider 10 from the open position to the closed position interlocks the male and female profiles 14, 15 so as to restrict access to the interior of the bag B. For example, the male and female tracks 14, 15 may be rolled or pressed into their interlocking arrangement so as to securely close the bag by one of two means. First, the tracks may be rolled or pressed together at one end by a user and then sequentially fitted together along the length of the fastener by the user running a finger along the length of the fastener on each side of the tracks. Alternatively, some bags employ a plastic slider that rides along the tracks of the fastener. If the slider is pulled in one direction, the bag is sealed shut; if the slider is pulled in the opposite direction, the bag is reopened.

As may be seen in FIG. 2, the slider 10 straddles the fastener 11 at the top of the bag B and is adapted for opening or closing the interlocking tracks 12, 13 of the fastener 11. The slider 10 may be molded from any suitable plastic including, but not limited to, nylon, polypropylene, polyethylene, polystyrene, copolymers of polyethylene and polypropylene, polycarbonates, polyesters, polyacetals, or acrylic-butadiene-styrene copolymers.

As shown in FIG. 2, the slider 10 comprises an inverted generally U-shaped member including a transverse support member or body 17 from which the separator finger 18 extends downward. The body 17 is itself U-shaped and includes two integral legs 19 extending downward. The finger 18 is positioned between the legs 19. The body 17 is adapted to move along the top edges of the tracks 12, 13 with the legs 19 straddling these elements and the finger 18 positioned between the tracks 12, 13. The slider 10 also includes a pair of hinged “wings” 20, 21 that can be folded down into their final position. The wings 20, 21 are hinged to the main slider body 17 by means of hinge structures 20a, 21a located at the opposite ends of the legs 19.

The foldable depending wings or side walls 20, 21 extend from an opening end 10a of the slider 10 to a closing end 10b. It is noted that the main slider body 17 and the separator finger 18 are wider at the opening end 10a than at the closing end 10b. Similarly, the side walls 20, 21 and the legs 19 are spaced wider apart at the opening end 10a of the slider 10 to permit separation of the male and female profiles 14, 15 by the finger 18 engaging the tracks 12, 13. The wings 20, 21 and legs 19 are spaced sufficiently close together at the closing end 10b of the slider to press the male and female profiles 14, 15 into an interlocking relationship as the slider 10 is moved in a fastener closing direction. As shown in FIG. 2, the side walls 20, 21 at their lower ends are provided with an inwardly extending shoulder structure 22. Shoulder structure 22 engages a bottom of the fastener 11 to prevent or inhibit slider 10 from being lifted off the edges of the tracks 12, 13 while the slider 10 straddles the fastener 11.

The opposite ends of the fastener 11 are typically provided with opposing end termination clips, such as end termination clip 23 of FIGS. 1-2. Each end clip 23 comprises a strap member which wraps over the top of the fastener 11. One end of the strap is provided with a rivet like member 23a which is adapted to penetrate through the bag material and into a cooperating opening 23b at the other end of the clip 23. The rivet 23a is then deformed so as to create a head locked into the opening 23b.

End termination clips may have various purposes such as (a) preventing or inhibiting the slider 10 from going past the ends of the fastener 11, (b) interacting with the slider 10 to give a tactile indication of being closed, (c) assisting in inhibiting or preventing leakage from the bag B and (d) holding the male and female profiles 14, 15 together and providing additional strength in resisting stresses applied to the profiles 14, 15 during normal use of the bag B. Further details concerning the construction and operation of the slider 10 and the end clips 23 may be obtained from U.S. Pat. No. 5,067,208 to Herrington, Jr. et al., which is incorporated herein by reference in its entirety.

It is contemplated that other end terminations may be used instead of the above-described end terminations clip 23. For example, an end weld may be formed by heated bars pressed against the end of the fastener, ultrasonic welding or other ways known in the art.

It also contemplated the fastener (not shown) which is used in bag B may be opened and closed either by finger pressure or an auxiliary squeezing device other than an auxiliary slider mechanism. In other words, a press to close type fastener may be used in bag B rather than a fastener having slider 10 as shown in FIGS. 1-2. Where a press to close type fastener is used in bag B, the tracks may have integrally formed profiles and fins.

As illustrated in FIG. 1, in order to open the bag B of the present invention, the consumer grips the slider mechanism 10 and moves it such that the male and female profiles 14, 15 of the respective fins 16a, 16b are detached from each other. Next, the consumer tears open the tamper evident feature 34 along the preferential area of weakness 39 joining the lower edges of the first and second fin portions 31, 33. The package can be resealed utilizing the reclosable fastener 11 and slider mechanism 10. Specifically, the consumer grips the slider mechanism 10 and moves it from the open position to the closed position so as to engage the complementary male and female profiles 14, 15.

The fins 16a, 16b and/or profiles 14, 15 of the present invention comprise at least one polymeric material which possesses excellent resistance to stress and superior strength properties. In particular, a cyclic olefin copolymer may be used in the fins 16a, 16b including the first and second fin portions 31, 33 and/or profiles 14, 15 of the bag B. It is contemplated that the fins 16a, 16b and/or profiles 14, 15 may comprise 100 wt. % cyclic olefin copolymer.

Alternatively, the fins 16a, 16b including the first and second fin portions 31, 33 and/or the profiles 14, 15 of the bag B may comprise a combination of a cyclic olefin copolymer and one or more additional polymers. Where a cyclic olefin copolymer and one or more additional polymers are used in forming the fins 16a, 16b and/or the profiles 14, 15 of the bag B, the cyclic olefin copolymer and the additional polymer(s) may be blended (i.e., into a monolayer) as shown in FIG. 3, for example.

The use of at least one polymeric material in the fins 16a, 16b and/or profiles 14, 15 as described herein significantly improves the strength of the fins 16a, 16b and/or profiles 14, 15 in comparison to fins 16a, 16b and/or profiles 14, 15 made from low density polyethylenes (LDPE), medium density polyethylenes (MDPE), high density polyethylenes (HDPE), and/or linear low density polyethylenes (LLDPE).

Where a cyclic olefin copolymer and one or more additional polymers are used in forming the fins 16a, 16b and/or the profiles 14, 15 of the bag B, the fins and/or profiles generally comprise from about 1 wt. % to about 99 wt. % of the cyclic olefin copolymer and from about 1 wt. % to about 99 wt. % of the additional polymer(s). In some embodiments, the fins and/or profiles comprise from about 1 wt. % to about 40 wt. % of the cyclic olefin copolymer and from about 60 wt. % to about 99 wt. % of the additional polymer(s). In other embodiments, the fins and/or profiles comprise from about 20 wt. % to about 40 wt. % of the cyclic olefin copolymer and from about 60 wt. % to about 80 wt. % of the additional polymer(s). The amount of cyclic olefin copolymer which is used in the fins and/or profiles depends on a variety of factors including, but not limited to, customer requirements, the applications in which the bags are used, the desired properties of the bags, cost, and the like.

It is also contemplated that in some embodiments, the opposing body panels 25, 26 may also comprise a cyclic olefin copolymer and/or a combination of a cyclic olefin copolymer and one or more additional polymers. Where a cyclic olefin copolymer and one or more additional polymers are used in forming the opposing body panels 25, 26 of the bag B, the cyclic olefin copolymer and the additional polymer(s) may be blended (i.e., into a monolayer).

Cyclic olefin copolymer

The cyclic olefin copolymers of the present invention generally have a molecular weight distribution or polydispersity (M_{W}/Mₙ, “MWD”) from about 2.0 to about 5.0, and preferably from about 2.0 to about 2.5. The cyclic olefin copolymers of the present invention are generally transparent and are generally miscible or compatible with certain polymers such as polyethylene.

The cyclic olefin copolymers generally have a density of from about 0.90 to about 1.10 g/cm³, typically from about 0.95 to about 1.05 g/cm³ and more typically from about 1.00 to about 1.03 g/cm³. The heat deflection temperature (HDT, measured at 66 psi) of cyclic olefin copolymers generally is from about 50 to about 200° C., and typically from about 70 to about 170° C.

The melt flow index (MI) of the cyclic olefin copolymers is generally from about 1 to about 100 g/10 min. and typically from about 4 to about 20 g/10 min. at 115° C. (239° F.) above its corresponding HDT as determined by ISO 1133.

The cyclic olefin copolymers may be made from copolymers of ethylene and norbornene. The mole % of ethylene and norbornene may vary with respect to each other. For example, the amount of norbornene is generally from about 10 to about 90 mol. %, with the remainder being ethylene (from about 10 to about 90 mol. %). The amount of norbornene is typically from about 20 to about 70 mol. % with the remainder being ethylene. The amount of norbornene is more typically from about 35 to about 60 mol. % with the remainder being ethylene. The cyclic olefin copolymers may be made using metallocene catalysts.

The glass transition temperature (T_{g}) of the cyclic olefin copolymer is generally greater than about 20° C., typically greater than about 50° C., and preferably greater than about 75° C., as measured by ASTM D3418. The glass transition temperature of the cyclic olefin copolymer may be greater than about 100° C. or about 150° C. as measured by ASTM D3418. The glass transition temperature (T_{g}) of the cyclic olefin copolymers increases as the mole % of norbornene in the copolymer increases. For example, the glass transition temperature (T_{g}) of a cyclic olefin copolymer comprising 20 mol. % norbornene and 80 mol. % ethylene is about 25° C., while the glass temperature transition of a cyclic olefin copolymer comprising 70 mol. % norbornene and 30 mol. % ethylene is about 210° C. The glass temperature transition (T_{g}) of a cyclic olefin copolymer comprising 30 mol. % norbornene and 70 mol. % ethylene is about 75° C., while a cyclic olefin copolymer comprising 60 mol. % norbornene and 40 mol. % ethylene is about 180° C.

The flexural modulus of the cyclic olefin copolymer is generally from about 300,000 to about 600,000 psi, and more specifically from about 400,000 to about 500,000 psi as measured by ASTM D790. The tensile modulus of the cyclic olefin copolymers is generally from about 300,000 to about 600,000 psi, and more specifically from about 400,000 to about 500,000 psi, as determined by ISO 527.

The moisture barrier properties of the cyclic olefin copolymer is generally from about 0.01 to about 0.06 g-mm/m²/day at 23° C. at 85% relative humidity, and more specifically from about 0.023 to about 0.045 g-mm/m²/day at 23° C. at 85% relative humidity as measured by DIN 53 122.

Useful cyclic olefin copolymers are available from several companies. For example, Ticona, a business of Celanese AG, in Summit, N.J. has cyclic olefin copolymers available. Other companies that have cyclic olefin copolymers available include Nippon Zeon Co., Ltd. (Japan) and Mitsui Chemical (Japan). Nippon Zeon Co., Ltd. has commercially available cyclic olefin copolymers (COCs) under the designation ZEONEX®. Ticona, a business of Celanese AG, has commercially available cyclic olefin copolymers (COCs) under the designation TOPAS®. The cyclic olefin copolymers which are commercially available under the designation TOPAS® are believed to be prepared with feedstocks of norbornene and ethylene and the use of a metallocene catalyst. There are believed to be at least four grades of TOPAS® resins available (TOPAS® 8007, TOPAS® 6013, TOPAS® 6015, and TOPAS® 6017). The four grades of TOPAS® resins available have glass transition temperatures, T_{g}, of 85, 140, 160 and 180° C, respectively. The corresponding norbornene levels of the four grades of TOPAS® resins are believed to be about 35, 48, 55 and 59 mol. %.

Additional Polymer(s)

The additional polymer(s) that may be used in forming the fins 16a, 16b and/or the profiles 14, 15 of the bag B include polyolefinic resins, engineering resins, or combinations thereof.

Nonlimiting examples of polyolefinic resins which may be used in combination with the cyclic olefin copolymers in the fins 16a, 16b and/or profiles 14, 15 include low density polyethylenes, linear low density polyethylenes, high density polyethylenes (HDPE), medium density polyethylenes (MDPE), polypropylenes, plastomers, elastomers, ethylene vinyl acetates (EVA), ethyl methacrylates, polymethylpentene copolymers, polyisobutylenes, polyolefin ionomers, or combinations thereof. It is contemplated that other polyolefinic resins may be used. The preferred polyolefinic resins are low density polyethylenes and linear low density polyethylenes. In some applications, the addition of one or more polyolefinic resins to the cyclic olefin copolymer may assist in enhancing the adhesion, toughness, tear resistance, and/or puncture resistance of the fins 16a, 16b and/or profiles 14, 15.

Where a polyolefinic resin is used, an alkenyl aromatic polymer (e.g., polystyrene, ethylene-styrene interpolymers, etc.) may also be used. For example, the alkenyl aromatic polymer may be added in an amount from about 0.1 wt. % to about 50 wt. % of the polyethylene. Further details may be obtained from U.S. Pat. Nos. 4,579,912; 4,716,201; 4,743,649; and 4,804,564.

Nonlimiting examples of engineering resins which may be used in combination with the cyclic olefin copolymers in the fins 16a, 16b and/or profiles 14, 15 include polycarbonates, polyesters, polyamides, polyacetals, polyacrylates, polysulfones, polyphenylene sulfides, polyphenylene ethers, liquid crystal polymers (LCPs), or combinations thereof. In some applications, the addition of one or more engineering resins to the cyclic olefin copolymer may assist in enhancing the modulus, dead fold properties, and/or thermal stability of the fins and/or profiles and may also assist in decreasing the shrinkage of the fins and/or profiles.

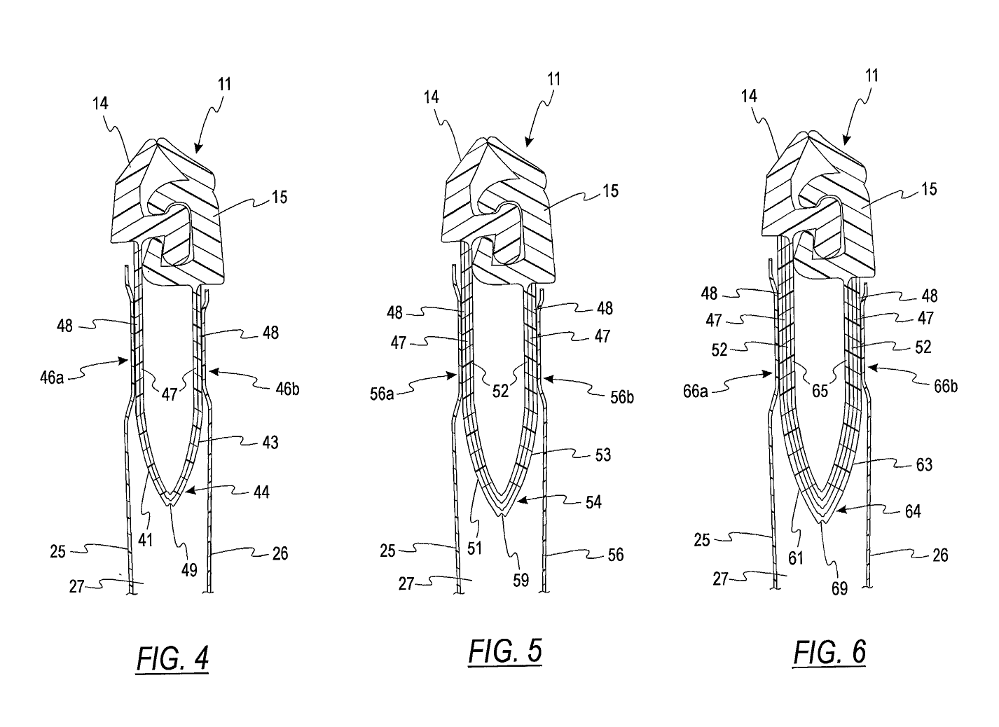

In another embodiment of the invention, the fins 16a, 16b may be formed of multiple layers such as shown in FIGS. 4-7. In a further embodiment of the invention, the joined first and second fin portions 31, 33 of the fins 16a, 16b may have varying shapes such as the generally M-shaped cross-sectional configuration shown in FIG. 8. In a still further embodiment of the invention, the profiles 14, 15 may be formed of multiple layers as shown in FIG. 9.

It is contemplated that the fins may be formed of multiple layers. Examples of fins which are formed of two, three, four, and five layers are depicted in FIGS. 4-7. Where a multiple layered fin structure is used, at least one of the layers may comprise the same materials as described above in making the fins 16a, 16b and/or the profiles 14, 15 of the bag B in the form of a monolayer. In other words, at least one of the layers may comprise a cyclic olefin copolymer and may optionally comprise an additional polymer(s) selected from polyolefinic resins, engineering resins, or combinations thereof as described above.

Nonlimiting examples of suitable additional layers that may be used in one or more of the layers in a multiple layered fin structure include a tie layer, a polyolefin(s) layer, a barrier layer, or a sealant layer. The materials which are selected for use in a fin structure having multiple layers may vary based on a variety of factors including, but not limited to, customer requirements, the applications in which the bags may be used, the desired properties of the bags, cost, and the like.

Nonlimiting examples of materials suitable for use in forming a tie layer include EVAs, anhydride modified polyolefins, anhydride modified ethylene-acrylates, anhydride modified EVAs, acid modified EVAs, acid modified ethylene-acrylates, amorphous polyolefin-modified EVA polymers or combinations thereof. Some examples of anhydride modified polyolefins include anhydride modified high density polyethylenes, anhydride modified low density polyethylenes and anhydride linear low density polyethylenes. Nonlimiting examples of materials suitable for use in forming a polyolefin layer include LDPEs, MDPEs, HDPEs, LLDPEs or combinations thereof.

Where a barrier layer is used, the barrier layer may be made from a material which is substantially impermeable to at least one of oxygen, nitrogen, carbon dioxide, water, and aroma. Nonlimiting examples of materials suitable for use in the barrier layer include vinyl alcohols, polyvinyl alcohols, nylons, polyesters, ethylene vinyl dichlorides, liquid crystal polymers, polyvinyl chlorides, polyvinylidene chlorides, modified polyolefins with barrier properties, polyacrylonitriles, acrylonitrile copolymers, polyacetals, cellophanes, or combinations thereof. Nonlimiting examples of materials suitable for use in forming a sealant layer include polypropylenes, plastomers, elastomers, EVAs, linear low density polyethylenes, ultra low density polyethylenes, functionalized polymers, and combinations thereof. Nonlimiting examples of suitable functionalized polymers include BYNEL® (products based on ethylene vinyl acetate, polyethylene, polypropylene, acid copolymers, and ethylene/acrylate copolymers) available from DuPont, layer is typically located adjacent the opposing body panels 25, 26.

It is also contemplated that oxygen absorbers and/or oxygen scavengers may be included in any of the layers. Oxygen absorbers or oxygen scavengers are generally chemical or enzyme based. Chemical oxygen scavengers contemplated in the present invention include metallic reducing agents such as various ferrous compounds, powdered iron oxide and metallic platinum. Other chemical oxygen scavengers include non-metallic formulations such as those employing ascorbic acids (Vitamin C) and their associated salts and organometallic molecules that have a natural affinity for oxygen.

Where a multiple layered fin structure is used, the placement of the layers may vary. In other words, the layers may be placed in any suitable configuration or arrangement and any one or more layers may contain a cyclic olefin copolymer. The configuration of the layers for use in a multiple-layered fin structure may vary based upon a variety of factors including, but not limited to, customer requirement(s), the applications in which the reclosable fasteners may be used, the desired property(s) of the reclosable fasteners, cost, the processing equipment, and the like.

Turning to FIG. 4, each of the fins 46a, 46b of fastener 11 comprises a first layer 47 and a second layer 48. The first and second fin portions 41, 43 of the fins 46a, 46b are joined to each other along a preferential area of weakness 49 to form the one-time openable tamper evident feature 44. The first and the second layers 47, 48 may be made of the same or different materials. The first layer 47 may comprise the same materials as described above in making the fins 16a, 16b and/or the profiles 14, 15 of the bag B in the form of a monolayer. In other words, the first layer 47 comprises a cyclic olefin copolymer and optionally comprises an additional polymer(s) as described above. The second layer 48 may be a tie layer, a polyolefin(s) layer, a barrier layer, or a sealant layer. As shown in FIG. 4, the second layer 48 may be connected to the opposing body panels 25, 26.

Numerous arrangements for fins having two layers are contemplated. For example, in one arrangement, the first layer 47 is made of cyclic olefin copolymer and the second layer 48 is made of a polyolefin such as LDPE, MDPE, HDPE, LLDPE, or a combination thereof. Alternatively, the first layer 47 may be made of a combination of a cyclic olefin copolymer and an additional polymer(s) as described above.

Referring to FIG. 5, the fins 56a, 56b of fastener 11 are similar to the fins 46a, 46b of FIG. 4 except that the fins further include a third layer 52. The first and second fin portions 51, 53 of the fins 56a, 56b are joined to each other along a preferential area of weakness 59 to form the one-time openable tamper evident feature 54. As shown in FIG. 5, the third layer 52 may be located on the interior of the bag such that the first layer 47 is located between the second layer 48 and the third layer 52. The third layer 52 of FIG. 5 may be made of similar materials as described above with respect to the first layer 47 or may be made of similar materials as described above with respect to the second layer 48.

Numerous arrangements for fins having three layers are contemplated. In one suitable three layer fin structure, the first layer 47 is made of a cyclic olefin copolymer, the second layer 48 is made of a polyolefin such as LDPE, MDPE, HDPE, LLDPE, or a combination thereof, and the third layer 52 is made from a polyolefin such as LDPE, MDPE, HDPE, LLDPE, or a combination thereof. Alternatively, the first layer 47 may be made of a combination of a cyclic olefin copolymer and an additional polymer(s) as described above.

In yet another suitable three layer arrangement, the first layer 47 may be made of a cyclic olefin copolymer and optionally an additional polymer(s), the second layer 48 may be a tie layer, and the third layer 52 may be made of a polyolefin(s). In a further suitable three layer arrangement, the first layer 47 may be made of a cyclic olefin copolymer and optionally an additional polymer(s), the second layer 48 may be a tie layer, and the third layer 52 may be a barrier layer.

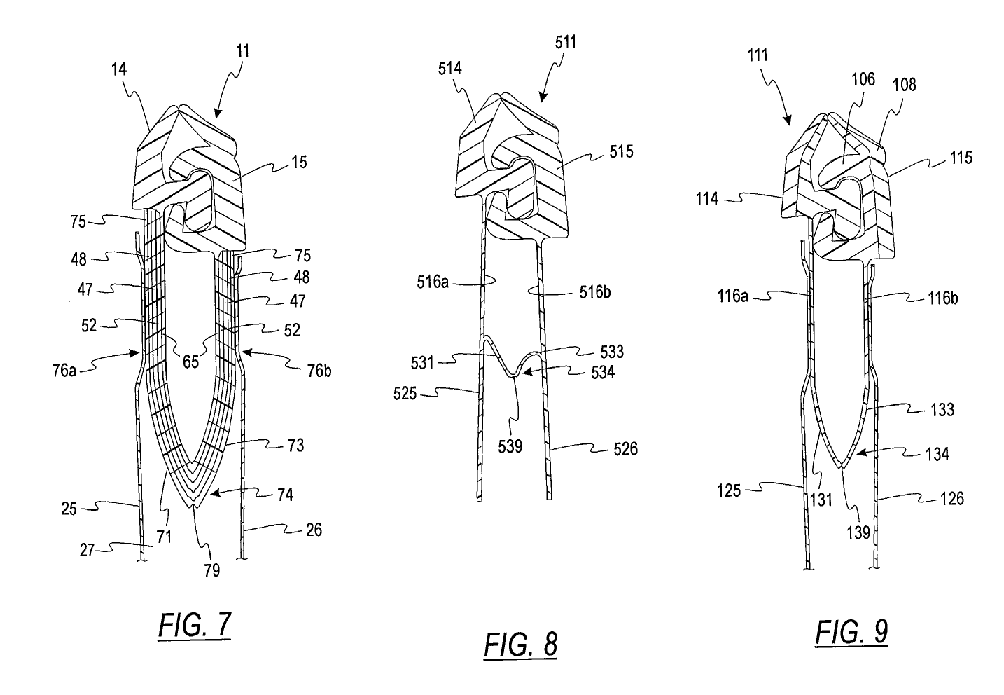

The fins used in the present invention may also include a fourth and a fifth layer such as shown in FIGS. 6-7. Referring first to FIG. 6, the fins 66a, 66b of fastener 11 further include a fourth layer 65. The first and second fin portions 61, 63 of the fins 66a, 66b are joined to each other along a preferential area of weakness 69 to form the one-time openable tamper evident feature 64. As shown in FIG. 6, the fourth layer 65 may be located on the interior of the bag such that the first layer 47 is located between the second layer 48 and the third layer 52 and the fourth layer 65 is adjacent to the third layer 52. The fourth layer 65 of FIG. 6 may be made of similar materials as described above with respect to the first layer 47 or may be made of similar materials as described above with respect to the second layer 48.

Numerous arrangements for fins having four layers are contemplated. In one suitable four layer fin structure, the first layer 47 is made of a cyclic olefin copolymer, the second layer 48 is made of a polyolefin, the third layer 52 is made from a polyolefin, and the fourth layer 65 is a barrier layer. Alternatively, the first layer 47 may be made of a combination of a cyclic olefin copolymer and an additional polymer(s) as described above.

In another suitable four-layered arrangement, the first layer 47 is made from a polyolefin, the second layer 48 is a barrier layer, the third layer 52 is made from a cyclic olefin copolymer, and the fourth layer 65 is made from a polyolefin. Alternatively, the third layer 52 may be made of a combination of a cyclic olefin copolymer and an additional polymer(s) as described above.

Other four layered fin structures are contemplated in the present invention. In another suitable four-layered fin structure, the first layer 47 is made from a polyolefin, the second layer 48 is a tie layer, the third layer 52 is made from a cyclic olefin copolymer, and the fourth layer 65 is made from a polyolefin. In yet another suitable four-layered fin structure, the first layer 47 is a barrier layer, the second layer 48 is made from a polyolefin, the third layer 52 is a tie layer, and the fourth layer 65 is made from a cyclic olefin copolymer.

Referring to FIG. 7, the fins 76a, 76b of fastener 11 further include a fifth layer 75. The first and second fin portions 71, 73 of the fins 76a, 76b are joined to each other along a preferential area of weakness 79 to form the one-time openable tamper evident feature 74. As shown in FIG. 7, the fifth layer 75 may be located on the interior of the fins 76a, 76b such that the first layer 47 is located between the second layer 48 and the third layer 52, the fourth layer 65 is adjacent to the third layer 52, and the fifth layer 75 is adjacent to the second layer 48. The fifth layer 75 of FIG. 7 may be made of similar materials as described above with respect to the first layer 47 or may be made of similar materials as described above with respect to the second layer 48.

Various arrangements for fins having five layers are contemplated. In one suitable five-layered fin structure, the first layer 47 is made of a cyclic olefin copolymer, the second layer 48 is made of a polyolefin, the third layer 52 is made from a polyolefin, the fourth layer 65 is a barrier layer, and the fifth layer 75 is a barrier layer. Alternatively, the first layer 47 may be made of a combination of a cyclic olefin copolymer and an additional polymer(s) as described above.

Other five layered fin structures are contemplated in the present invention. In another suitable five-layered fin structure, the first layer 47 is a barrier layer, the second layer 48 is a tie layer, the third layer 52 is a tie layer, and the fourth layer 65 is made from a cyclic olefin copolymer, and the fifth layer 75 is made from a polyolefin.

It is also contemplated that additional layers may be added in forming the fins of the present invention. For example, six, seven, or more layered fins are contemplated in the present invention.

It is also contemplated that the male profile may have more than one depending fin extending downward from the male profile and that that the female profile may have more than one depending fin extending downward from the female profile (not shown). In this embodiment, the fins may be in the form of a monolayer or a multiple-layered structure as described above. In this embodiment, the fins associated with the male profile may be located on the exterior of the bag and/or on the interior of the bag. In addition, the fins associated with the male profile may be located on the exterior of the bag and/or on the interior of the bag.

The fins, such as shown in FIGS. 4-7, may be formed by coextruding the multiple layers that form each fin. The fins may also be formed by other processes such as coating or laminating including extrusion laminating or adhesive laminating. The thicknesses of the fins may vary from generally about 2 mils to about 10 mils. The thicknesses of the fins are typically from about 4 mils to about 8 mils and more typically from about 5 mils to about 7 mils.

It is also contemplated that the first and second fin portions of the fins may be joined in a variety of configurations. Examples of suitable configurations of the joined first and second fin portions of the fins include, but are not limited to, generally U-shaped, generally V-shaped, and generally M-shaped cross-sectional configurations. FIG. 8 shows an alternative embodiment of the invention having fins 516a, 516b formed of a single layer where the first and second fin portions 531, 533 of the fins 516a, 516b are joined in a generally M-shaped cross-sectional configuration. Where the first and second fin portions of the fins are joined in a variety of configurations, it is contemplated that the fins may be formed of multiple layers.

As discussed above, in a further embodiment of the invention, the profiles may also be formed of multiple layers. Profiles which are formed of two layers are depicted in FIG. 9. It is also contemplated that the profiles may have, for example, three, four, five, or more layers (not shown).

Where a multiple layered profile structure is used, at least one of the layers may comprise the same materials as described above in making the fins 16a, 16b and/or the profiles 14, 15 of the bag B in the form of a monolayer. In other words, at least one of the layers may comprise a cyclic olefin copolymer and may optionally comprise an additional polymer(s) as described above.

Where a multiple layered profile structure is used, it is also contemplated that the first and second fin portions of the fins may be joined to each other along a one-time breakable preferential area of weakness or preferential tear area to form a one-time openable tamper evident feature. Where a multiple layered profile structure is used, it is also contemplated that the fins including the first and second fin portions may comprise the same materials as described above in making the fins 16a, 16b and/or the profiles 14, 15 of the bag B in the form of a monolayer. In other words, the fins including the first and second fin portions may comprise a cyclic olefin copolymer and may optionally comprise an additional polymer(s) as described above.

Nonlimiting examples of suitable additional layers that may be used in one or more of the layers in a multiple layered profile structure include a polyolefin(s) layer, a barrier layer, a tie layer, or a sealant layer. The materials which are selected for use in a profile structure having multiple layers may vary based on a variety of factors including, but not limited to, customer requirements, the applications in which the bags may be used, the desired properties of the bags, cost, and the like.

Where a multiple layered profile structure is used, the placement of the layers may vary. In other words, the layers may be placed in any suitable configuration or arrangement and any one or more layers may contain a cyclic olefin copolymer. The configuration of the layers for use in a multiple-layered profile structure may vary based upon a variety of factors including, but not limited to, customer requirement(s), the applications in which the reclosable fasteners may be used, the desired property(s) of the reclosable fasteners, cost, the processing equipment, and the like.

FIG. 9 shows a suitable fastener 111 for use in embodiments of the invention that includes a male profile 114 and a female profile 115. As shown in FIG. 9, each of the profiles 114, 115 comprises a first layer 106 and a second layer 108. The first and the second layer 106, 108 may be made of the same or different materials. The first layer 106 may comprise the same materials as described above in making the profiles and/or the fins of the bag in the form of a monolayer. In other words, the first layer 106 may comprise a cyclic olefin copolymer and may optionally comprise an additional polymer(s) as described above. The second layer 108 may be a polyolefin(s) layer, a barrier layer, a tie layer, or a sealant layer. As shown in FIG. 9, the first and second fin portions 131, 133 of the fins 116a, 116b are joined to each other along a preferential area of weakness 139 to form a one-time openable tamper evident feature 134.

Numerous arrangements for profiles having two layers are contemplated. For example, in one arrangement, the first layer 106 may be made of a cyclic olefin copolymer and the second layer 108 may be made of a polyolefin such as LDPE, MDPE, HDPE, LLDPE, or a combination thereof. Alternatively, the first layer 106 may be made of a combination of a cyclic olefin copolymer and an additional polymer(s) as described above.

As discussed above, a three layered profile structure (not shown) is contemplated in the present invention. In one suitable three-layered profile embodiment, the first layer is made of a cyclic olefin copolymer, the second layer is made of a polyolefin, and the third layer is made from a polyolefin. Alternatively, the first layer may be made of a combination of a cyclic olefin copolymer and an additional polymer(s) as described above. Although a multitude of configurations are contemplated, the layer comprising the cyclic olefin copolymer is preferably the central layer.

The profiles, such as shown in FIG. 9, may be formed by coextruding the multiple layers that form each profile. The profiles may also be formed by other processes such as coating or laminating including extrusion laminating or adhesive laminating. The thicknesses of the profiles may vary from generally about 10 mils to about 45 mils. The thicknesses of the profiles are typically from about 15 mils to about 30 mils.

Although the profiles for use in embodiments of the invention have been described in connection with those shown in FIGS. 1-9, additional male and female profiles may be used in embodiments of the invention. Any interlocking male and female profile having complementary cross-sectional shapes may be used. The alternative male and female profiles which may be used in embodiments of the invention may use an auxiliary slider mechanism or may have a press to close type fastener which may be opened and closed either by finger pressure or an auxiliary squeezing device other than an auxiliary slider mechanism.

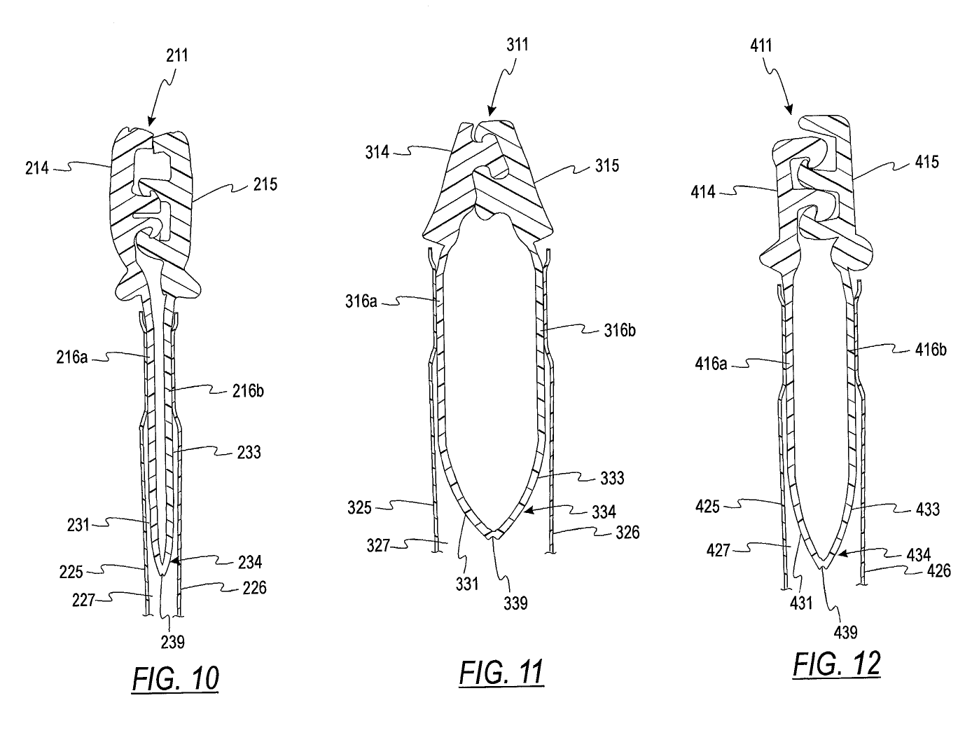

Nonlimiting examples of additional cross-sectional shapes of interlocking male and female profiles which are suitable for use in embodiments of the invention are shown in FIGS. 10-12. FIG. 10 shows a suitable fastener 211 for use in embodiments of the invention that includes a male profile 214 and a female profile 215 and first and second fin portions 231, 233 of the fins 216a, 216b that are joined to each other along a preferential area of weakness 239 to form the one-time openable tamper evident feature 234. FIG. 11 shows another example of a suitable fastener 311 for use in embodiments of the invention that includes a male profile 314 and a female profile 315 and first and second fin portions 331, 333 of the fins 316a, 316b that are joined to each other along a preferential area of weakness 339 to form the one-time openable tamper evident feature 334. FIG. 12 shows yet another example of a suitable fastener 411 for use in embodiments of the invention that includes a male profile 414 and a female profile 415 and first and second fin portions 431, 433 of the fins 416a, 416b that are joined to each other along a preferential area of weakness 439 to form the one-time openable tamper evident feature 434.

FIGS. 1-12 depict alternative embodiments of bags having both tamper evident features as well as reclosable fastener arrangements. The tamper evident feature not only provides a consumer with the assurance that his or her newly purchased bag has never been opened before but also provides a very good initial seal which preserves the freshness of the food contents of the bag prior to its initial opening. Since the reclosable closure arrangement is located above the tamper evident feature, the operation of the reclosable closure arrangement is not hampered by the presence of the tamper evident feature.

It is contemplated that additional materials may be added in forming the fins and/or the profiles. These materials include various fillers such as clay, talc, mica, calcium carbonate, wood flour, glass sphere, glass fibers, pigments, and nanoclays which may be more cost effective. These materials may be blended with other materials in the formation of the fins and/or the profiles. These materials may be added in a sufficient amount so that the fins and/or the profiles have the properties which are desired for a given application.

### EXAMPLE 1

### Top Retention Test

Three bags (Bags 2-4) were formed having slider tracks with profiles composed of TOPAS® 8007 and polyethylene. The profiles contained 10, 20, and 40 weight percent of TOPAS® 8007 respectively. A fourth control bag (Bag 1) having a slider track with a profile composed of polyethylene was also formed.

The tracks of Bags 1-4 were tested in a SINTECH® tensile strength tester available from MTS Systems in Cary, N.C. to measure the top retention of the slider (i.e., the force required to pull the slider off of the top of a bag) using the following procedure:

1. The bag was placed into the tensile strength tester so that the slider adapter was located in the top jaw of the equipment;

2. 4″ were cut from the top of the bag;

3. The slider was moved near the center of the track;

4. The slider was moved into the slider adapter and centered in the slider adapter;

5. The film was placed into the bottom jaw of the tensile strength tester;

6. The jaws of the tensile strength tester were closed; and

7. The force to pull the slider off of the track was measured.

Steps 1-7 were run five (5) times for each track sample and then averaged. The results shown below in Table A demonstrate that the top retention of the slider increased with increasing weight percents of TOPAS® in the profile.

TABLE A

| | Weight % of | Weight % of | |
|---|---|---|---|
| | TOPAS ® 8007 | Polyethylene in | |
| Bag No. | in Profile | Profile¹ | Top Retention (lbs) |
| 1(Control) | 0 | 100 | 17.1 |
| 2 | 10 | 90 | 18.6 |
| 3 | 20 | 80 | 20.7 |
| 4 | 40 | 60 | 22.4 |

### EXAMPLE 2

### Track Open Force Test

The slider tracks of Bags 1-4 were tested in a SINTECH® tensile strength tester to measure the amount of force required to open the track (i.e., the amount of force required to pull the male and female profile apart to open the track by pulling on the fins) using the following procedure:

1. The jaw separation on the tensile tester was set at 2″;

2. The film containing the male profile was placed into the top jaw of the tensile tester and the film containing the female profile was placed into the bottom jaw of the tensile tester;

3. The jaws were closed; and

4. The fins of each track sample were pulled until the track opened (i. e., until the male and female profile pulled apart).

Steps 1-4 were run five (5) times for each track sample and then averaged. The standard deviation was also calculated for each track sample. The results shown below in Table B demonstrate that the open force of the slider increased with higher weight percents (e.g., 40%) of TOPAS® in the profile.

TABLE B

| | Weight % of | Weight % of | |
|---|---|---|---|
| | TOPAS ® 8007 | Polyethylene in | |
| Bag No. | in Profile | Profile¹ | Open Force (lbs) |
| 1(Control) | 0 | 100 | 16.0 |
| 2 | 10 | 90 | 15.1 |
| 3 | 20 | 80 | 15.1 |
| 4 | 40 | 60 | 23.7 |

¹This weight percent included additional additives not exceeding approximately 1-2 wt. %. The additional addities included a white pigment and a slip and process aid available from Ampacet in Tarrytown, New York.

### EXAMPLE 3

### Dead Fold Retention Test

The slider tracks of Bags 1-4 were tested on a dead fold tester having a minimum of 40 psi air supply manufactured by Aurnou Gage, Inc. in Rochester, N.Y. to measure the dead fold or crease retention of the track (i.e., the ability of the track to maintain its position once the track has been bent or folded) using the following procedure:

1. The fins of each sample were cut from the track,

2. The track was separated;

3. The male and female sides of the track were cut to 7″ in length;

4. The track was placed smooth side down into the grooved portion of the dead fold tester so that the edge of the track was perpendicular to and touching the end stop of the dead fold tester;

5. The right clamp of the dead fold tester was tightened,

6. The opposite edge of the track was folded over to the right edge of the dead fold tester guides;

7. The left clamp of the dead fold tester was tightened;

8. A weight was lowered by depressing the toggle switch on the dead fold tester;

9. A timer was started once the weight was lying on the track;

10. The weight was released after thirty (30) seconds;

11. The track was allowed to relax for thirty (30) seconds; and

12. The angle formed by the dead fold was measured.

Steps 1-12 were run thirty (30) times for each track sample and then averaged. The standard deviation was also calculated for each track sample. The results shown below in Table C demonstrate that the dead fold angle improved (i.e., got smaller) with increasing weight percents of TOPAS® in the profile. These results also show that increasing the weight percents of TOPAS® in the profile improved the ability of the track to maintain its position once it has been bent or folded.

TABLE C

| | Weight % of | Weight % of | Dead Fold Angle (°) | Dead Fold Angle (°) |
|---|---|---|---|---|
| | TOPAS ® 8007 | Polyethylene in | of the | of the |
| Bag No. | in Profile | Profile¹ | Male Profile | Female Profile |
| 1(Control) | 0 | 100 | 170 | 170 |
| 2 | 10 | 90 | 127 | 114 |
| 3 | 20 | 80 | 83 | 80 |
| 4 | 40 | 60 | 56 | 55 |

¹This weight percent included additional additives not exceeding approximately 1-2 wt. %. The additional additives included a white pigment and a slip and process aid available from Ampacet in Tarrytown, New York.

### EXAMPLE 4

### Track Shrinkage Test

Three bags (Bags 6-8) were formed having slider tracks with profiles composed of TOPAS® 6013 and polyethylene. The profiles were composed of 10, 20, and 40 weight percent of TOPAS® 6013 respectively. Two bags (Bags 3-4) having slider tracks with profiles as described in Example 1 above were also formed. A sixth control bag (Bag 5) having a slider track with a profile composed of polyethylene was also formed.

The profiles of each of the six track samples were separated and labeled as male or female profile. The profiles were then cut using a 100 mm×100 mm template. Four samples of the six male and female profiles were cut.

A heated fluidized bath of aluminum oxide was used to measure the unrestrained shrinkage characteristics of the profiles of each of the six track samples. The heated fluidized bath used was a TECHNE® SBS2 manufactured by Techne Corporation in Princeton, N.J. and was capable of 80 standard cubic feet per hour with a minimum of 40 psi air supply. A temperature controller having a temperature probe capable of maintaining the temperature of the fluidized bath at ±2° F. was used. The temperature controller used was a TECHNE® TC8D manufactured by Techne Corporation in Princeton, N.J.

The instruments were prepared according to the following procedure:

1. The wires were attached to the temperature controller from the fluidized bath;

2. The temperature probe was inserted into the receptacle on the side of the fluidized bath so that the tip of the probe was in the middle of the bath;

3. The level of aluminum oxide in the bath was checked to ensure it measured approximately 2″ from the top edge of the bath;

4. The fluidized bath was connected to a minimum 40 psi air supply;

5. The airflow regulator was set to 80 standard cubic feet per hour (scfh) and was adjusted slightly as needed to prevent the aluminum oxide from overflowing;

6. The fluidized bath dial was set to maximum setting of 10;

7. The temperature regulator was turned on and set at a temperature of 240° F. although the temperature could vary depending on the components of the sample being tested for shrinkage;

8. The 12″×½″ rod extending from the ringstand over the bath was adjusted so the handle of the wire mesh sample cage rested on the rod and the top of the cage was positioned at least ½″ below the surface of the aluminum oxide bath; and

9. The timer was set for 60 seconds where applicable.

The four samples of the six male and female profiles were tested on the heated fluidized bath of aluminum oxide to measure the unrestrained shrinkage characteristics of the profiles (i.e., the amount each profile shrinks when raised in a relaxed state to a predetermined temperature for a set amount of time) using the procedure set forth below.

1. The temperature controller was checked to make sure the fluidized bath was set at the specified temperature of 240° F.±2° F.;

2. The twenty four samples (four sets of the six male and female profiles) were placed in the sample cage;

3. The timer was started;

4. The sample cage was smoothly immersed into the fluidized bath so the samples were at least ½″ below the upper portion of the aluminum oxide;

5. The sample cage was removed after a 60 second submersion;

6. The excess aluminum oxide was poured off of the samples;

7. The samples were removed from the cage, laid on a flat surface, and allowed to cool; and

8. Excess aluminum oxide was brushed off of the samples and any curling of the samples was smoothed out.

Since the original dimension of the samples was exactly 100 mm, the percent shrinkage was read by placing the 100 mm mark at the end of the sample and reading the percent change in millimeters from the opposite parallel edge. Where a material became elongated, it was recorded as a negative shrinkage value. Where a material became shortened, it was recorded as a positive shrinkage value. The average percent shrinkage of the four sets of six male and female profiles was recorded and the standard deviation was calculated. The results are shown below in Table D.

TABLE D

| | Weight % of | | Weight % of | | | |
|---|---|---|---|---|---|---|
| | TOPAS ® | | Polyethylene | | Percent | |
| | in Profile | | In Profile | | Shrinkage of | |
| Bag | | Weight % | | Weight % | the Profile (%) | |
| No. | Type | TOPAS ® | Type | Polyethylene¹ | Male | Female |
| 5 | Control | 0 | Control | 100 | 53.0 | 52.7 |
| 3 | 8007 | 20 | 8007 | 80 | 6.5 | 6.9 |
| 4 | 8007 | 40 | 8007 | 60 | 8.3 | 7.1 |
| 6 | 6013 | 10 | 6013 | 90 | 1.7 | 1.0 |
| 7 | 6013 | 20 | 6013 | 80 | 0.4 | 0.1 |
| 8 | 6013 | 40 | 6013 | 60 | 0.2 | 0.1 |

¹This weight percent included additional additives not exceeding approximately 1-2 wt. %. The additional additives included a white pigment and a slip and process aid available from Ampacet in Tarrytown, New York.

The results shown above in Table D demonstrate that the addition of TOPAS® 8007 or TOPAS® 6013 to the profiles reduced the shrinkage of the profiles.

### EXAMPLE 5

### Track Curvature Test

Three bags (Bags 10-12) were formed having slider tracks with profiles composed of TOPAS® 6013 and polyethylene. The profiles were composed of 5, 10, and 15 weight percent of TOPAS® 6013 respectively. A fourth bag (Bag 9) having a slider track with a profile composed of polyethylene was also formed.

The track curvature (i.e., how much the track is bent in the same plane as the fin and the profile) of each of the four track samples was measured using the following procedure:

1. A 25″ piece of track was cut;

2. The track was placed flat on a board with the profile located against the dowel pins in the board which were spaced 24″ apart; and

3. The amount of curvature was measured off a scale in the center of the board in 1/32″. In particular, the distance from zero to the edge of the profile was recorded.

The results shown below in Table E show that the curvature decreased (i.e., became straighter) with increased weight percents of TOPAS® in the profile.

TABLE E

| | Weight % of | Weight % of | |
|---|---|---|---|
| | TOPAS ® 6013 in | Polyethylene in | Curvature of the |
| Bag No. | Profile | Profile¹ | Track |
| 9(Control) | 0 | 100 | +36/32” |
| 10 | 5 | 95 | +29/32” |
| 11 | 10 | 90 | +16/32” |
| 12 | 15 | 85 | +3/32” |

¹This weight percent included additional additives not exceeding approximately 1-2 wt. %. The additional additives included a white pigment and a slip and process aid available from Ampacet in Tarrytown, New York.

### EXAMPLE 6

### Seal Strength Test

Three films (Films 2-4) having a thickness of 1 mil were made with varying weight percents of TOPAS® 6013 in LLDPE. Films 2-4 were composed of 5, 10, and 20 weight percent of TOPAS® 6013 respectively. A fourth control film (Film 1) composed of LLDPE having a thickness of 1 mil was also formed.

Films 1-4 were cut into 10″ long and 1″ wide pieces. Two 10″×1″ pieces of each of the four films were glued together using a THELLER® HT heatsealer available from Theller Engineering in Petaluma, California using the following sealing procedure:

1. The aluminum hot seal bars on the top and the bottom of the THELLER® HT heatsealer were set to the following temperatures: 250° F., 275° F.,300° F., 325° F., and 350° F.;

2. The top seal bar of the THELLER® HT heatsealer was covered with 5 mils of a Teflon/glass cloth tape;

3. The bottom seal bar of the THELLER® HT heatsealer, which had a 26 mil silicone rubber pad, was covered with 5 mils of a Teflon/glass cloth tape,

4. The jaw closure was sealed on the two 10″×1″ pieces of each test sample for 1500 msec at a sealing unit pressure of 60 psig; and

5. The two 10″×1″ pieces of each test sample were cooled in still room air at 72° F.

The web tension both during and after sealing was almost zero (i.e., 0.5 gm).

Tensile tests were then performed on the four glued film test samples using a SINTECH® tensile strength tester in peel mode (T-configuration or method). The full 1″ width of each test sample was clamped into the upper and lower air actuated jaws of the tensile strength tester and subjected to the following test conditions:

1. Near zero initial tension in the sample;

2. 2″ initial jaw separation; and

3. 20 in./min jaw separation speed.

The results of the tensile tests shown below in Table F demonstrate that the heat seal strength (shown in pounds/linear inch (pli)) (i.e., how much force a seal will withstand before breaking when stretched) of the films increased at all heat seal temperatures with increasing weight percents of TOPAS® in the film.

TABLE F

| | Weight % | Weight | | | | | |
|---|---|---|---|---|---|---|---|
| | of | % of | | | | | |
| | TOPAS ® | LLDPE | Seal Bar Temperature (° F.) | | | | |
| | 6013 in | in the | 250 | 275 | 300 | 325 | 350 |
| Film # | the Film | Film | Heat Seal Strength (pli) | | | | |
| 1(control) | 0 | 100 | 2.334 | 2.055 | 2.397 | 2.166 | 1.948 |
| 2 | 5 | 95 | 2.734 | 3.043 | 2.881 | 2.52 | 2.738 |
| 3 | 10 | 90 | 3.578 | 3.506 | 3.558 | 3.555 | 4.913 |
| 4 | 20 | 80 | 4.557 | 4.443 | 4.123 | 4.227 | 6.083 |

### EXAMPLE 7

### Oil Release Test

Two films (Films 6-7) having a thickness of 2 mils were made containing 20 and 50 weight percent of TOPAS®6013 in LLDPE respectively. A third control film (Film 5) composed of LLDPE having a thickness of 2 mils was also formed.

An oil residue test for cheese was performed on the three films. In particular, one gram of sliced cheese was placed on a 5×5″ piece of each of the three films and heated in a microwave for 30 seconds. The melted cheese which remained on each of the three films was cooled to room temperature and removed with a flipper. The percentage of the cheese which remained on each of the three films was then calculated. The results are shown below in Table G.

TABLE G

| | Weight % of | | % Cheese Remaining |
|---|---|---|---|
| | TOPAS ® | Weight % of | on Film After |
| | 6013 in the | LLDPE in the | Heating, Cooling |
| Film # | Film | Film | and Removal Steps |
| 5(control) | 0 | 100 | 6.0 |
| 6 | 20 | 80 | 1.5 |
| 7 | 50 | 50 | 0.8 |

The results shown above in Table G demonstrate that the addition of TOPAS® to the films improved its oil releasing properties.

### EXAMPLE 8

### Modulus Enhancement Test

Films of varying thicknesses (Films 2-4, 6, and 9-13) were made with varying weight percents of TOPAS® 6013 in LLDPE as shown below in Table H. Control films (Films 1, 5, and 8) made of LLDPE at varying thicknesses were also formed.

The films were tested to measure the machine direction modulus (i.e., the initial resistance of a material to stretching). The results shown below in Table H demonstrate that the addition of TOPAS® to LLPDE films improved the machine direction modulus of the film as measured by ASTM D882.

TABLE H

| | Film | | | Machine |
|---|---|---|---|---|
| | thickness | Weight % of | Weight % of | Direction |
| Film # | (mil) | TOPAS ® 6013 | LLDPE | Modulus (psi) |
| 8(Control) | 0.5 | 0 | 100 | 32666 |
| 9 | 0.5 | 5 | 95 | 55743 |
| 10 | 0.5 | 10 | 90 | 71722 |
| 11 | 0.5 | 20 | 80 | 102524 |
| 1(Control) | 1 | 0 | 100 | 33963 |
| 2 | 1 | 5 | 95 | 44557 |
| 3 | 1 | 10 | 90 | 58804 |
| 4 | 1 | 20 | 80 | 90947 |
| 5(Control) | 2 | 0 | 100 | 32256 |
| 12 | 2 | 5 | 95 | 42459 |
| 13 | 2 | 10 | 90 | 63474 |
| 6 | 2 | 20 | 80 | 92655 |

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A fastener for a plastic bag comprising:
a male track including a male profile and a first fin, the first fin extending from the male profile, the first fin having a first fin portion; and
a female track including a female profile and a second fin, the second fin extending from the female profile, the second fin having a second fin portion, the first and second fin portions being joined to each other along a one-time breakable preferential area of weakness, at least one of the first and second fins comprising a cyclic olefin copolymer, the cyclic olefin copolymer having a glass transition temperature, T_{g}, of greater than about 20° C. as determined by ASTM D3418.

2. The fastener of claim 1, wherein at least one of the first and second fins comprise at least a second polymer selected from a polyolefinic resin, an engineering resin, and a combination thereof.

3. The fastener of claim 2, wherein the polyolefinic resin is selected from low density polyethylenes, linear low density polyethylenes, high density polyethylenes, medium density polyethylenes, polypropylenes, plastomers, elastomers, ethylene vinyl acetates, ethyl methacrylates, polymethylpentene copolymers, polyisobutylenes, polyolefin ionomers, and combinations thereof.

4. The fastener of claim 3, wherein at least one of the first and second fins further comprise an alkenyl aromatic polymer.

5. The fastener of claim 2, wherein the engineering resin is selected from polycarbonates, polyesters, polyamides, polyacetals, polyacrylates, polysulfones, polyphenylene sulfides, polyphenylene ethers, liquid crystal polymers, and combinations thereof.

6. The fastener of claim 2, wherein at least one of the first and second fins comprise from about 1 to about 99 wt. % of the cyclic olefin copolymer and from about 1 to about 99 wt. % of the second polymer.

7. The fastener of claim 1, wherein the cyclic olefin copolymer comprises from about 10 to about 90 mol. % of norbornene.

8. The fastener of claim 1, wherein the glass transition temperature, T_{g}, of the cyclic olefin copolymer is greater than about 50° C. as determined by ASTM D3418.

9. The fastener of claim 1, wherein at least one of the first and second fins further comprise a filler selected from clay, talc, mica, calcium carbonate, wood flour, glass sphere, glass fibers, pigments, and nanoclays.

10. A fastener for a plastic bag comprising:
a male track including a male profile and a first fin, the first fin extending from the male profile, the first fin having a first fin portion; and
a female track including a female profile and a second fin, the second fin extending from the female profile, the second fin having a second fin portion, the first and second fin portions being joined to each other along a one-time breakable preferential area of weakness, at least one of the male and female profiles comprising a cyclic olefin copolymer, the cyclic olefin copolymer having a glass transition temperature, T_{g}, of greater than about 20° C. as determined by ASTM D3418.

11. The fastener of claim 10, wherein at least one of the first and second fins comprise at least a second polymer selected from a polyolefinic resin, an engineering resin, and a combination thereof.

12. The fastener of claim 11, wherein the polyolefinic resin is selected from low density polyethylenes, linear low density polyethylenes, high density polyethylenes, medium density polyethylenes, polypropylenes, plastomers, elastomers, ethylene vinyl acetates, ethyl methacrylates, polymethylpentene copolymers, polyisobutylenes, polyolefin ionomers, and combinations thereof.

13. The fastener of claim 12, wherein at least one of the first and second fins further comprise an alkenyl aromatic polymer.

14. The fastener of claim 11, wherein the engineering resin is selected from polycarbonates, polyesters, polyamides, polyacetals, polyacrylates, polysulfones, polyphenylene sulfides, polyphenylene ethers, liquid crystal polymers, and combinations thereof.

15. The fastener of claim 11, wherein at least one of the first and second fins comprise from about 1 to about 99 wt. % of the cyclic olefin copolymer and from about 1 to about 99 wt. % of the second polymer.

16. The fastener of claim 10, wherein the cyclic olefin copolymer comprises from about 10 to about 90 mol. % of norbornene.

17. The fastener of claim 10, wherein the glass transition temperature, T_{g}, of the cyclic olefin copolymer is greater than about 50° C. as determined by ASTM D3418.

18. The fastener of claim 10, wherein at least one of the first and second fins further comprise a filler selected from clay, talc, mica, calcium carbonate, wood flour, glass sphere, glass fibers, pigments, and nanoclays.

19. A polymeric bag comprising:
first and second opposing body panels fixedly connected to each other along a pair of sides and a bottom bridging the pair of sides; and
a reclosable fastener extending along a mouth formed opposite the bottom, the fastener including a pair of interlocking flexible plastic tracks, the plastic tracks including a male track including a male profile and a first fin, the first fin extending from the male profile, the first fin having a first fin portion, and a female track including a female profile and a second fin, the second fin extending from the female profile, the second fin having a second fin portion, the first and second fin portions being joined to each other along a one-time breakable preferential area of weakness to inhibit tampering with the bag, at least one of the first and second fins comprising a cyclic olefin copolymer, the cyclic olefin copolymer having a glass transition temperature, T_{g}, of greater than about 20° C. as determined by ASTM D3418.

20. The bag of claim 19, wherein the bag further comprises a slider slidably mounted to the fastener for movement between a closed position and an open position.

21. The bag of claim 19, wherein at least one of the first and second fins comprise at least a second polymer selected from a polyolefinic resin, an engineering resin, and a combination thereof.

22. The bag of claim 21, wherein the polyolefinic resin is selected from low density polyethylenes, linear low density polyethylenes, high density polyethylenes, medium density polyethylenes, polypropylenes, plastomers, elastomers, ethylene vinyl acetates, ethyl methacrylates, polymethylpentene copolymers, polyisobutylenes, polyolefin ionomers, and combinations thereof.

23. The bag of claim 21, wherein the engineering resin is selected from polycarbonates, polyesters, polyamides, polyacetals, polyacrylates, polysulfones, polyphenylene sulfides, polyphenylene ethers, liquid crystal polymers, and combinations thereof.

24. The bag of claim 21, wherein at least one of the first and second fins comprise from about 1 to about 99 wt. % of the cyclic olefin copolymer and from about 1 to about 99 wt. % of the second polymer.

25. The bag of claim 19, wherein the cyclic olefin copolymer comprises from about 10 to about 90 mol. % of norbornene.

26. A polymeric bag comprising:
first and second opposing body panels fixedly connected to each other along a pair of sides and a bottom bridging the pair of sides; and
a reclosable fastener extending along a mouth formed opposite the bottom, the fastener including a pair of interlocking flexible plastic tracks, the plastic tracks including a male track including a male profile and a first fin, the first fin extending from the male profile, the first fin having a first fin portion, and a female track including a female profile and a second fin, the second fin extending from the female profile, the second fin having a second fin portion, the first and second fin portions being joined to each other along a one-time breakable preferential area of weakness to inhibit tampering with the bag, at least one of the male and female profiles comprising a cyclic olefin copolymer, the cyclic olefin copolymer having a glass transition temperature, T_{g}, of greater than about 20° C. as determined by ASTM D3418.

27. The bag of claim 26, wherein the bag further comprises a slider slidably mounted to the fastener for movement between a closed position and an open position.

28. The bag of claim 26, wherein at least one of the male and female profiles comprise at least a second polymer selected from a polyolefinic resin, an engineering resin, and a combination thereof.

29. The bag of claim 28, wherein the polyolefinic resin is selected from low density polyethylenes, linear low density polyethylenes, high density polyethylenes, medium density polyethylenes, polypropylenes, plastomers, elastomers, ethylene vinyl acetates, ethyl methacrylates, polymethylpentene copolymers, polyisobutylenes, polyolefin ionomers, and combinations thereof.

30. The bag of claim 28, wherein the engineering resin is selected from polycarbonates, polyesters, polyamides, polyacetals, polyacrylates, polysulfones, polyphenylene sulfides, polyphenylene ethers, liquid crystal polymers, and combinations thereof.

31. The bag of claim 28, wherein at least one of the male and female profiles comprise from about 1 to about 99 wt. % of the cyclic olefin copolymer and from about 1 to about 99 wt. % of the second polymer.

32. The bag of claim 26, wherein the cyclic olefin copolymer comprises from about 10 to about 90 mol. % of norbornene.
